(19) United States
(12) Patent Application Publication
(10) Pub. No.: US 2021/0009832 A1
(43) Pub. Date: Jan. 14, 2021

(54) WATER-BASED INK FOR INK-JET RECORDING

(71) Applicant: BROTHER KOGYO KABUSHIKI KAISHA, Nagoya-shi (JP)

(72) Inventors: Nozomi SUZUKI, Nisshin-shi (JP); Mitsunori MAEDA, Nagoya-shi (JP)

(73) Assignee: BROTHER KOGYO KABUSHIKI KAISHA, Nagoya-shi (JP)

(21) Appl. No.: 16/925,484

(22) Filed: Jul. 10, 2020

(30) Foreign Application Priority Data
Jul. 12, 2019 (JP) 2019-130462

(51) Int. Cl. C09D 11/322; C09B 48/00

(52) U.S. Cl. CPC C09D 11/322; C09B 48/00

(57) ABSTRACT

A water-based ink for ink-jet recording, includes: a solid solution of a quinacridone pigment including C.I. Pigment Violet 19 and C.I. Pigment Red 122, an azo pigment including C.I. Pigment Red 48:3, and water.

### CROSS REFERENCE TO REBATED APPLICATION

The present application claims priority from Japanese Patent Application No. 2019-130462 filed on Jul. 12, 2019, the disclosure of which is incorporated herein by reference in its entirety.

### BACKGROUND OF THE INVENTION

### Field of the Invention

The present disclosure is related to a water-based ink for ink-jet recording.

### Description of the Related Art

There is well known for improving characteristics of a water-based ink for ink-jet recording by using a solid solution that contains two kinds of pigments in the water-based ink (see, for example, Patent Literature 1: Japanese Patent Application Laid-open Publication No. 2018-150515 corresponding to United States Patent Application Publication No. US2018/0258302).

In view of visibility, a red-based color is important in ink-jet recording. Although it is considered that the red-based color is produced or obtained by improving a red ink, the red-based color is preferably obtained by improving a magenta ink that is one of three primary colors of yellow, magenta, and cyan.

However, when a desired color is attempted to be reproduced by a solid solution containing two kinds of pigments, a color reproduction range is likely to be narrow and a chromaticness of a mixed color portion is likely to be decreased. In order to solve those problems, a wide color reproduction gamut from magenta (hue angle approximately −40°) to red (hue angle approximately 40°) is required to be high, and the improvement of a magenta chromaticness and a recording density is also required.

In view of the above, an object of the present disclosure is to provide a water-based ink for ink-jet recording in which a wide color reproduction gamut from magenta to red is achieved and a magenta chromaticness and a recording density (namely, an optical density) are good.

### SUMMARY OF THE INVENTION

According to the present disclosure, there is provided a water-based ink for ink-jet recording, including:

a solid solution of a quinacridone pigment including C.I. Pigment Violet 19 and C.I. Pigment Red 122,

an azo pigment including C.I. Pigment Red 48:3, and

water.

### BRIEF DESCRIPTION OF THE DRAWINGS

FIG. 1 is a graph explaining a synergetic effect of the present disclosure, wherein colors (chromaticity) in evaluation samples of Examples 1 to 8 and Comparative Examples 1 and 2 that are produced in (a) hue angle evaluation are represented on an L*a*b* color system chromaticity diagram in which a* and b* are represented on a plane.

FIG. 2 is a schematic perspective view of an exemplary configuration of an ink-jet recording apparatus according to the present disclosure.

### DESCRIPTION OF THE PREFERRED EMBODIMENT

In the present disclosure, a chromaticness (C*) is calculated, for example, by the following formula using a* and b* based on an L*a*b* color system (CIE 1976 (L*a*b*) color system) normalized or standardized by Commission Internationale d'Eclairage (CIE) in 1976 (see, JIS Z 8729).

C*={(a*²)+(b*²)}^{1/2}

In the present disclosure, a hue angle means, for example, an angle in accordance with an L*a*b* color system chromaticity diagram (a*−b* plane) in which a* and b* are represented on a plane. The hue angle is defined as follows:

when satisfying a*≥0 and b*>0 (the first quadrant), the hue angle is tan⁻¹ (b*/a*);

when satisfying a*≤0 and b*≥0 (the second quadrant), the hue angle is 180°+tan⁻¹ (b*/a*);

when satisfying a*≤0 and b*≤0 (the third quadrant), the hue angle is 180°+tan⁻¹ (b*/a*); and

when satisfying a*≥0 and b*≤0 (the fourth quadrant), the hue angle is 360°+tan⁻¹ (b*/a*).

A water-based ink for ink-jet recording of the present disclosure (hereinafter referred to as “water-based ink” or “ink” in some cases) is explained. The water-based ink of the present disclosure contains a quinacridone pigment, an azo pigment, and water.

The quinacridone pigment contains a solid solution that contains C.I. Pigment Violet 19 (hereinafter referred to as “PV19” in some cases) and C.I. Pigment Red 122 (hereinafter referred to as “PR122” in some cases). In the present disclosure, the “solid solution” indicates a pigment existing as a mixed crystal (a crystallized state of two or more kinds of pigment molecules in a mixed state) of two or more kinds of pigment molecules, and is different from one obtained by simply mixing two or more kinds of pigments. The solid solution may be a quinacridone pigment that contains at least PV19 and PR122. The solid solution may or may not contain a quinacridone pigment different from PV19 and PR122 (hereinafter referred to as “any other pigment”). When the solid solution contains any other pigment described above, a ratio of a content of any other pigment described above in an entire amount of the solid solution is, for example, smaller than a content of the solid solution in an entire amount of the water-based ink and a content of C.I. Pigment Red 48:3 in the entire amount of the water-based ink. The ratio of the content of any other pigment described above in the entire amount of the solid solution is, for example, less than 0.3% by mass, not more than 0.1% by mass, or 0% by mass. The solid solution containing PV19 and PR122 may be any commercially available product, or may be produced by a publicly known producing method.

The content (Q) of the quinacridone pigment in the entire amount of the water-based ink is, for example, 2 to 6.4% by mass, 3 to 5.6% by mass, or 3.3 to 5.6% by mass.

Only the solid solution that contains PV19 and PR122 may be used as the quinacridone pigment in the water-based ink. Further, the water-based ink may contain not only the solid solution that contains PV19 and PR122 but also a quinacridone pigment different from the solid solution that contains PV19 and PR122. In the water-based ink, the mass ratio of the solid solution that contains PV19 and PR122 in the entire amount of the quinacridone pigment is, for example, not less than 50% by mass, not less than 70% by mass, or 100% by mass.

The azo pigment contains C.I. Pigment Red 48:3 (hereinafter referred to as “PR48:3” in some cases). C.I. Pigment Red 48:3 does not form solid solution with any other pigment, namely, C.I. Pigment Red 48:3 is a non-solid solution pigment dispersed in the water-based ink.

The content (A) of the azo pigment in the water-based ink is, for example, 0.8 to 4% by mass, 1 to 2.8% by mass, or 1.1 to 2.8% by mass.

Only the PR48:3 may be used as the azo pigment in the water-based ink. Further, the water-based ink may contain not only PR48:3 but also any other azo pigment than PR48:3. In the water-based ink, the mass ratio of PR48:3 in the entire amount of the azo pigment is, for example, not less than 50% by mass, not less than 70% by mass, or 100% by mass.

Since PR48:3 and the solid solution that contains PV19 and PR122 are used together in the water-based ink, a wide color reproduction gamut from magenta to red can be achieved and a magenta chromaticness and a recording density are good in the water-based ink.

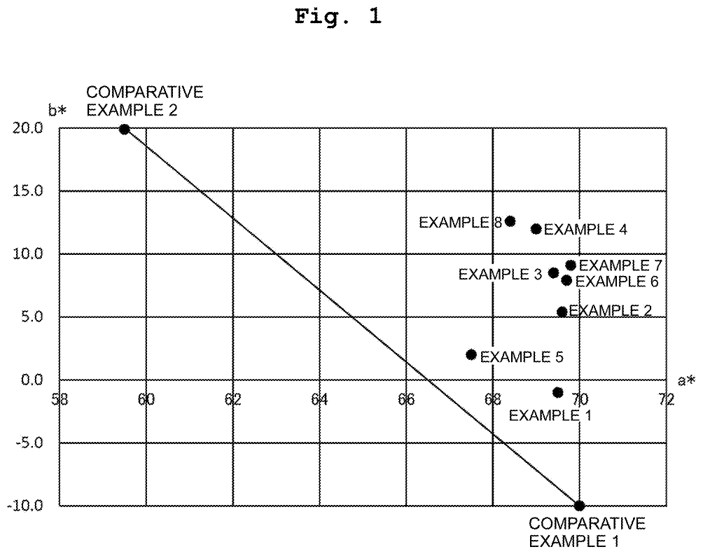

For example, a color (chromaticity) of an image formed using the water-based ink of the present disclosure is plotted at a position where the chromaticness is high (a position away from the origin) in an area from magenta to red (hue angle approximately −40° to approximately 40°) in an a*−b* plane. This means the water-based ink of the present disclosure can achieve the wide color reproduction gamut from magenta to red. The effect (the wide color reproduction gamut) of the water-based ink of the present disclosure exceeds an intermediate level that is an arithmetic average of PR48:3 and the solid solution of PV19 and PR122. As depicted in FIG. 1, the intermediate level that is the arithmetic average is on a straight line connecting a plot of Comparative Example 1 described below in which the solid solution of PV19 and PR122 was used alone and a plot of Comparative Example 2 described below in which PR48:3 was used alone. On the other hand, in each of Examples 1 to 8 described below in which PR48:3 and the solid solution of PV19 and PR122 were used together, a* and b* exceeded the straight line and showed a synergetic effect. Here, in the water-based ink (each of Examples 1 to 8) of the present disclosure, “a* and b* exceeded the straight line” means that the straight line is located between the plot of the water-based ink of the present disclosure and the origin in the a*−b* plane shown in FIG. 1. Namely, it means that the chromaticness of the water-based ink of the present disclosure is higher than the chromaticness of the water-based ink plotted on the straight line having the same hue angle as the water-based ink of the present disclosure. It is presumed that the water-based ink of the present disclosure achieves the above-described synergetic effect because intrinsic absorption peaks of PV19, PR122 and PR48:3 appropriately overlap. This mechanism, however, is merely a presumption, and the present disclosure is not limited to or restricted by this presumed mechanism. The a* and b* are based on the L*a*b* color system (CIE 1976 (L*a*b*) color system) normalized or standardized by Commission Internationale d′Eclairage (CIE) in 1976 (see, HS Z 8729).

A mass ratio of the content (Q) of the quinacridone pigment to the content (A) of the azo pigment in the entire amount of the water-based ink is, for example, Q:A=8:2 to 5:5 or Q:A=8:2 to 6:4.

A total (Q+A) of the content (Q) of the quinacridone pigment and the content (A) of the azo pigment in the entire amount of the water-based ink is, for example, 4 to 8% by mass, 5 to 7% by mass, or 5.5 to 7% by mass.

When the mass ratio satisfies Q:A=8:2 to 6:4 and the total (Q+A) is 5 to 7% by mass, it is possible to obtain the water-based ink in which a balance between the hue angle and the magenta chromaticness and the recording density is good.

When the mass ratio satisfies Q:A=8:2 to 6:4 and the total (Q A) is 5.5 to 7% by mass, it is possible to obtain the water-based ink in which the balance between the hue angle and the magenta chromaticness and the recording density is good and the recording density is especially good.

The water-based ink may or may not contain not only the quinacridone pigment and the azo pigment but also any other pigment than the quinacridone pigment and the azo pigment, dye, and the like.

Pigments that may be used in the water-based ink, including the quinacridone pigment and the azo pigment, are exemplified, for example, by C.I. Pigment Reds 2, 3, 5, 6, 7, 12, 15, 16, 48, 48:1, 53:1, 57, 57:1, 112, 122, 123, 139, 144, 146, 149, 150, 166, 168, 175, 176, 177, 178, 184, 185, 190, 202, 221, 222, 224, and 238; C.I. Pigment Violets 19 and 196; C.I. Pigment Yellows 1, 2, 3, 12, 13, 14, 15, 16, 17, 55, 73, 74, 75, 78, 83, 93, 94, 95, 97, 98, 114, 128, 129, 138, 150, 151, 154, 180, 185, and 194; and C.I. Pigment Oranges 31 and 43. Among those, the quinacridone pigment and the azo pigment are preferably used.

The water-based ink may be prepared by dispersing the pigment in water with a dispersant. As the dispersant, it is allowable to use, for example, a general-purpose polymeric dispersant (resin for dispersing pigment, pigment-dispersing resin), etc. The pigment may be a self-dispersible pigment. The self-dispersible pigment is dispersible in water without using any dispersant, for example, owing to the fact that at least one of a hydrophilic group and the salt thereof including, for example, carbonyl group, hydroxyl group, carboxylic acid group, sulfonic acid group (sulfonate group), phosphoric acid group (phosphate group), etc. is introduced into the surfaces of the particles of the self-dispersible pigment by the chemical bond directly or with any group intervening therebetween.

The water is preferably ion-exchange water or purified water (pure water). The content of the water in the entire amount of the water-based ink is, for example, 10 to 90% by mass, or 20 to 80% by mass. The content of the water also may be, for example, a balance of the other components.

The water-based ink may further contain a surfactant. The surfactant is exemplified, for example, by an acetylenic glycol-based surfactant.

A commercially available product may be used as the acetylenic glycol-based surfactant. Examples of the commercially available product include “OLFIN (trade name) E1004”, “OLFIN (trade name) E1008”, and “OLFIN (trade name) E1010” produced by Nissin Chemical Industry Co., Ltd; “Surfynol (trade name) 440”, “Surfynol (trade name) 465”, and “Surfynol (trade name) 485” produced by Air Products and Chemicals, Inc.; and “ACETYLENOL (trade name) E40” and “ACETYLENOL (trade name) E100” produced by Kawaken Fine Chemicals Co., Ltd.

In addition to or instead of the acetylenic glycol-based surfactant, the water-based ink may contain any other surfactant(s), which is/are exemplified, for example, by nonionic surfactants produced by KAO CORPORATION, including “EMULGEN (trade name)” series, “RHEODOL (trade name)” series, “EMASOL (trade name)” series, “EXCEL (trade name)” series, “EMANON (trade name)” series, “AMIET (trade name)” series, “AMINON (trade name)” series; nonionic surfactants produced by TOHO CHEMICAL INDUSTRY CO., LTD., including “SOLVON (trade name)” series; nonionic surfactants produced by Lion Corporation, including “DOBANOX (trade name)” series, “LEOCOL (trade name)” series, “LEOX (trade name)” series, “LAOL, LEOCON (trade name)” series, “LIONOL (trade name)” series, “CADENAX (trade name)” series, “LIONON (trade name)” series, “LEOFAT (trade name)” series; anionic surfactants produced by KAO CORPORATION including “EMAL (trade name)” series, “LATEMUL (trade name)” series, “VENOL (trade name)” series, “NEOPELEX (trade name)” series, NS SOAP, KS SOAP, OS SOAP, and “PELEX (trade name)” series; anionic surfactants produced by Lion Corporation, including “LIPOLAN (trade name)” series, “UPON (trade name)” series, “SUNNOL (trade name)” series, “LIPOTAC (trade name)” series, “ENAGICOL (trade name)” series, “LIPAL (trade name)” series, and “LOTAT (trade name)” series; and cationic surfactants “KACHIOGEN (trade name) ES-OW” and “KACHIOGEN (trade name) ES-L” produced by Dai-Ichi Kogyo Seiyaku Co., Ltd. The surfactant(s) may be used alone or in a combination of two or more thereof.

For example, the ratio of the content of the surfactant to a total of 100 parts by mass of the content of the quinacridone pigment and the content of the azo pigment is not less than 4 parts by mass, or 25 to 50 parts by mass. By making the ratio of the content of the surfactant within the above range, ink droplets are appropriately wet and spread on the surface of the recording medium, and thus an image quality is expected to be improved. Further, for example, the ratio of the content of the acetylenic glycol-based surfactant to the total of 100 parts by mass of the content of the quinacridone pigment and the content of the azo pigment may be 12.5 to 25 parts by mass.

The water-based ink may further contain a water-soluble organic solvent. The water-soluble organic solvent is exemplified, for example, by a humectant that inhibits ink from drying at an end of a nozzle in an ink jet head and a penetrant that adjusts the dry speed of the water-based ink on a recording medium.

Examples of the humectant include, but not limited to, lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols (ketone alcohols) such as diacetone alcohol; ethers such as tetrahydrofuran and dioxane; polyethers such as polyalkylene glycol; polyvalent alcohols such as alkylene glycol, glycerol, trimethylolpropane, and trimethylolethane; 2-pyrrolidone; N-methyl-2-pyrrolidone; and 1,3-dimethyl-2-imidazolidinone. The polyalkylene glycol is exemplified, for example, by polyethylene glycol and polypropylene glycol. The alkylene glycol is exemplified, for example, by ethylene glycol, propylene glycol, butylene glycol, diethylene glycol, triethylene glycol, dipropylene glycol, tripropylene glycol, thiodiglycol, and hexylene glycol. Those may be used alone or in a combination of two or more thereof. Among them, polyvalent alcohol(s) such as alkylene glycol and glycerol is/are preferably used.

The content of the humectant(s) in the entire amount of the water-based ink is, for example, 0 to 95% by mass, 5 to 80% by mass, or 5 to 50% by mass.

An example of the penetrant is glycol ether. Examples of the glycol ether include ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, trimethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, and tripropylene glycol-n-butyl ether. The penetrant(s) may be used alone or in a combination of two or more thereof.

The content of the penetrant(s) in the entire amount of the water-based ink is, for example, 0 to 20% by mass, 0 to 15% by mass, or 1 to 6% by mass.

The water-based ink may further contain a conventionally known additive, as necessary. The additive is exemplified, for example, by pH-adjusting agents, viscosity-adjusting agents, surface tension-adjusting agents, fungicides, and fixing agents for gloss paper. The viscosity-adjusting agents are exemplified, for example, by polyvinyl alcohol, cellulose, water-soluble resins, and the like.

The water-based ink can be prepared, for example, by uniformly mixing, for example, the quinacridone pigment, the azo pigment, the water, and an optionally other additive(s) as necessary, by a conventionally known method, and then removing any non-dissolved matter, with a filter or the like.

The hue angle of the water-based ink may be, for example, −5° to 11° or −1° to 7°. The above range of the hue angle is near the center of the magenta to red range. By making the hue angle of the water-based ink in the above range, a wide color reproduction gamut from magenta to red is easy to be achieved when printing is performed in combination with another color (for example, yellow, etc). The hue angle of the water-based ink may be measured by forming each evaluation sample using the water-based ink and measuring its hue angle as explained in (a) Hue Angle Evaluation in Examples described below.

As described above, since C.I. Pigment Red 48:3 and the solid solution that contains C.I. Pigment Violet 19 and C.I. Pigment Red 122 are used together in the water-based ink for ink-jet recording of the present disclosure, a wide color reproduction gamut from magenta to red can be achieved and a magenta chromaticness and a recording density are good in the water-based ink.

Subsequently, an ink jet recording apparatus of the present disclosure is explained.

The ink-jet recording apparatus of the present disclosure is an ink jet recording apparatus including: an ink accommodating section and an ink jetting mechanism. Ink is accommodated in the ink accommodating section and the ink accommodated in the ink accommodating section is jetted by the ink jetting mechanism. The water-based ink for ink-jet recording of the present disclosure is accommodated in the ink accommodating section.

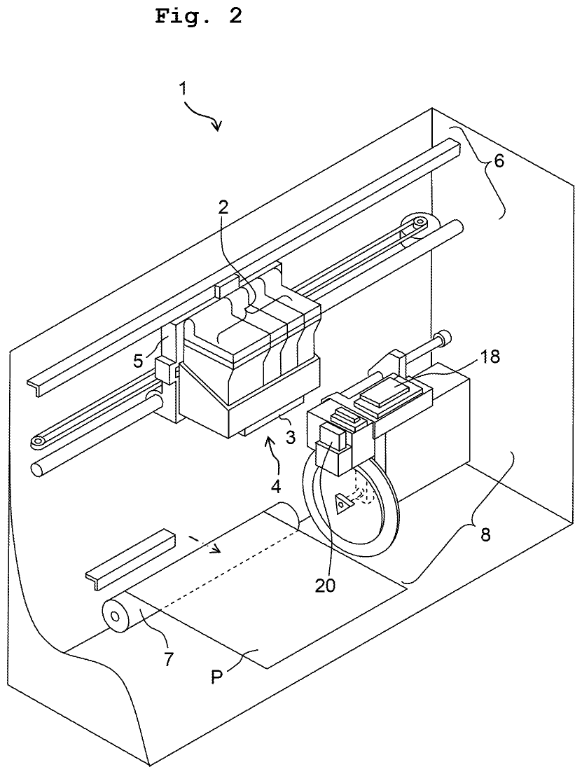

FIG. 2 depicts an exemplary configuration of the ink-jet recording apparatus of the present disclosure. As depicted in FIG. 2, an ink jet recording apparatus 1 includes four ink cartridges 2, an ink jetting mechanism (ink-jet head) 3, a head unit 4, a carriage 5, a driving unit 6, a platen roller 7 and a purge device 8 as main constitutive components or parts of the ink-jet recording apparatus 1.

Each of the four ink cartridges 2 contains one of four water-based inks of yellow, magenta, cyan, and black. For example, the water-based magenta ink is the water-based ink for ink-jet recording of the present disclosure. In this example, a set with the four ink cartridges 2 is explained. However, instead of this set, the present disclosure may use an integrated type ink cartridge of which interior is comparted (partitioned) to form a water-based yellow ink accommodating section, a water-based magenta ink accommodating section, a water-based cyan ink accommodating section, and a water-based black ink accommodating section. As a body of the ink cartridge, for example, any conventionally known main body of an ink cartridge may be used.

The ink-jet head 3 disposed on the head unit 4 performs recording on a recording medium P (e.g., recording paper). The four ink cartridges 2 and the head unit 4 are provided or arranged on the carriage 5. The driving unit 6 causes the carriage 5 to reciprocate in a linear direction. As the driving unit 6, it is possible to use, for example, a conventionally known driving unit (see, for example, Japanese Patent Application laid-open No. 2008-246821 corresponding to United States Patent Application Publication No. US2008/0241398 A1). The platen roller 7 extends in the reciprocating direction of the carriage 5 and is arranged to face the ink jet head 3.

The purge device 8 sucks or draws unsatisfactory ink (poor ink) which contains air bubbles, etc., accumulated or trapped in the inside of the ink-jet head 3. As the purge device 8, it is possible to use, for example, a conventionally known purge device (for example, see Japanese Patent Application laid-open No. 2008-246821 corresponding to United States Patent Application Publication No. US2008/0241398 A1).

A wiper member 20 is provided on the purge device 8 at a position on the side of the platen roller 7 such that the wiper member 20 is adjacent to the purge device 8. The wiper member 20 has a spatula shape, and wipes a nozzle-formed surface of the ink-jet head 3 accompanying with the movement (reciprocating movement) of the carriage 5. In FIG. 2, a cap 18 is provided to cover nozzles of the ink-jet head 3 that is returned to a reset position upon completion of recording, so as to inhibit the water-based inks from drying.

In the ink jet recording apparatus 1 of this example, the four ink cartridges 2 are provided, together with the head unit 4, on one carriage 5. The present disclosure, however, is not limited to this. In the ink-jet recording apparatus 1, the respective four ink cartridges 2 may be provided on a carriage which is different (separate) from the carriage on which the head unit 4 is provided. Alternatively, the respective four ink cartridges 2 may be arranged and fixed inside the ink-jet recording apparatus 1, rather than being provided on the carriage 5. In such aspects, for example, the four ink cartridges 2 are connected to the head unit 4 provided on the carriage 5 via tubes, etc., and the water-based inks are supplied from the four ink cartridges 2, respectively, to the head unit 4. Further, in these aspects, it is allowable to use four ink bottles having a bottle shape as the ink containers, instead of using the four ink cartridges 2. In such a case, each of the ink bottles is preferably provided with an inlet port via which the ink is poured from the outside to the inside of each of the ink bottles.

Ink-jet recording using the ink jet recording apparatus 1 is performed, for example, as follows. At first, the recording paper P is supplied or fed from a paper feeding cassette (not depicted in the drawing) arranged at a side of or at a position below the ink-jet recording apparatus 1. The recording paper P is introduced or guided between the ink-jet head 3 and the platen roller 7. Then, predefined recording is performed on the fed or introduced recording paper P with the water-based ink(s) jetted from the ink jet head 3. The recording paper P after recording is discharged from the ink-jet recording apparatus 1. In FIG. 2, illustration of the feed mechanism and discharge mechanism for the recording paper P is omitted.

In the apparatus depicted in FIG. 2, a serial type ink-jet head is adopted. The present disclosure, however, is not limited to this. The ink-jet recording apparatus may be an apparatus adopting a line type ink-jet head.

### EXAMPLES

Next, examples of the present disclosure are explained together with comparative examples. The present disclosure is not limited and is not restricted to the examples and the comparative examples described below.

[Preparation of Pigment Dispersion Liquids A to D]

Purified water was added to 20% by mass of a pigment (solid solution of PV19 and PR122) and 7% by mass of a sodium hydroxide neutralized product of a styrene-acrylic acid copolymer (acid value 175 mgKOH/g, molecular weight 10,000), so that the sum of them was 100% by mass, followed by being stirred (agitated) and mixed with each other. This mixture was put in a wet sand mill using zirconia beads with a diameter of 0.3 mm as a medium to perform dispersion treatment for six hours. After that, the zirconia beads were removed by a separator, and the mixture obtained was filtrated through a cellulose acetate filter (pore size 3.00 μm). A pigment dispersion liquid A indicated in Tables 1 and 2 was thus obtained. The styrene-acrylic acid copolymer was a water-soluble polymer that was generally used as the resin dispersant of the pigment. Pigment dispersion liquids B to D indicated in Tables 1 and 2 were each obtained in a similar manner as the pigment dispersion liquid A, except that the type of pigment, the ratio of components, and the dispersion treatment time were changed appropriately.

### Examples 1 to 13 and Comparative Examples 1 to 4

Components included in the ink composition (Table 1 or 2), except for the pigment dispersion liquids A to D, were mixed uniformly or homogeneously; and thus an ink solvent was obtained. Subsequently, the ink solvent was added to each of the pigment dispersion liquids A to D, followed by being mixed uniformly, and thus a mixture was obtained. After that, the mixture obtained was filtrated through a cellulose acetate membrane filter (pore size 3.00 μm) manufactured by TOYO ROSHI KAISHA, LTD., and thus the water-based ink for ink-jet recording in each of Examples 1 to 13 indicated in Table 1 and the water-based ink for ink-jet recording in each of Comparative Examples 1 to 4 indicated in Table 2 were obtained.

With respect to the water-based inks of Examples 1 to 13 and Comparative example 1 to 4, (a) evaluation for hue angle, (b) evaluation for magenta chromaticness, and (c) evaluation for recording density were performed by the following methods.

(a) Hue Angle Evaluation

Evaluation samples were made by applying the water-based inks in Examples and Comparative Examples on recording mediums (“Hammermill Fore Multi-Purpose Paper” manufactured by International Paper) so that the application amount per unit area was approximately 0.90 mg/cm². The hue angle was measured at five portions in each of the evaluation samples by using a spectrophotometer (spectrophotometric colorimetry meter) SpectroEye produced by X-Rite, an average value thereof was determined, and the hue angle was evaluated in accordance with the following evaluation criteria.

<Evaluation Criteria for Hue Angle Evaluation>

A: Hue angle was not less than −1° and not more than 7°;
B: Hue angle was not less than −5° and less than −1°, or exceeded 7° and not more than 11°;
C: Hue angle was less than −5° or exceeded 11°.

(b) Magenta Chromaticness Evaluation

The chromaticness (C*) was measured at five portions in each of the evaluation samples for (a) hue angle evaluation by using the spectrophotometer SpectroEye. Then, an average value thereof was determined and the magenta chromaticness was evaluated in accordance with the following evaluation criteria.

<Evaluation Criteria for Magenta Chromaticness Evaluation>

A: Chromaticness (C*) was not less than 70
B: Chromaticness (C*) was not less than 66 and less than 70
C: Chromaticness (C*) was less than 66

(d) Evaluation for Recording Density

The Optical density (OD value) of five portions in each of the evaluation samples for (a) hue angle evaluation was measured by using the spectrophotometric colorimetry meter SpectroEye (light source: D₅₀; field: 2°, ANSI-T). Then, an average value thereof was determined and the recording density was evaluated in accordance with the following evaluation criteria.

<Evaluation Criteria for Recording Density Evaluation>

AA: The optical density (OD value) was not less than 1.3;
A: The optical density (OD value) was not less than 1.2 and less than 1.3;
B: The optical density (OD value) was not less than 1.1 and less than 1.2;
C: The optical density (OD value) was less than 1.1.

Tables 1 and 2 indicate ink compositions and evaluation results in Examples 1 to 13 and Comparative Examples 1 to 4.

### Table 1 (Following)—Legend

*1 Aqueous dispersion of solid solution of PV19 and PR122; numerical values in Table 1 indicate the solid content amounts of pigment
*2 Aqueous dispersion of PR48:3; numerical values in Table 1 indicate the solid content amounts of pigment
*3 Nonionic surfactant (acetylenic glycol-based surfactant) produced by Nissin Chemical Industry Co., Ltd; the numeric value in Table 1 indicates the active ingredient amount
*4 Anionic surfactant produced by Lion Corporation; active ingredient 28% by weight; the numeric value in Table 1 indicates the active ingredient amount.
Unit of the ink composition is % by mass.

TABLE 1

| | | | Examples | | | | | | | | |
|---|---|---|---|---|---|---|---|---|---|---|---|
| | | | 1 | 2 | 3 | 4 | 5 | 6 | 7 | 8 | 9 |
| Ink | Quinacridone | Pigment dispersion | 2.8 | 2.5 | 3 | 3.5 | 4 | 3.3 | 3.85 | 4.4 | 4.2 |
| composition | pigment (Q) | liquid A (*1) | | | | | | | | | |
| | Azo | Pigment dispersion | 1.2 | 2.5 | 2 | 1.5 | 1 | 2.2 | 1.65 | 1.1 | 1.8 |
| | pigment (A) | liquid B (*2) | | | | | | | | | |
| | Humectant | Glycerol | 8 | 8 | 8 | 8 | 8 | 8 | 8 | 8 | 8 |
| | | Triethylene glycol | 8 | 8 | 8 | 8 | 8 | 8 | 8 | 8 | 8 |
| | Penetrant | Triethylene | 2 | 2 | 2 | 2 | 2 | 2 | 2 | 2 | 2 |
| | | glycol-n-butyl ether | | | | | | | | | |
| | Surfactant | OLFIN (trade name) | 1 | 1 | 1 | 1 | 1 | 1 | 1 | 1 | 1 |
| | | E1010 (*3) | | | | | | | | | |
| | | SUNNOL (trade name) | 1 | 1 | 1 | 1 | 1 | 1 | 1 | 1 | 1 |
| | | NL1430 (*4) | | | | | | | | | |

| | | | | | | | | | |
|---|---|---|---|---|---|---|---|---|---|
| Water | balance | balance | balance | balance | balance | balance | balance | balance | balance |

| | | | | | | | | | |
|---|---|---|---|---|---|---|---|---|---|
| Q:A | 7:3 | 5:5 | 6:4 | 7:3 | 8:2 | 6:4 | 7:3 | 8:2 | 7:3 |
| Q + A | 4 | 5 | 5 | 5 | 5 | 5.5 | 5.5 | 5.5 | 6 |
| Hue angle | A | B | A | A | A | A | A | A | A |
| Magenta chromaticness | B | A | A | A | A | A | A | A | A |
| Recording density | B | A | A | A | A | AA | AA | AA | AA |

| | | | Examples | | | |
|---|---|---|---|---|---|---|
| | | | 10 | 11 | 12 | 13 |
| Ink composition | Quinacridone | Pigment dispersion | 4.2 | 4.9 | 5.6 | 5.6 |
| | pigment (Q) | liquid A (*1) | | | | |
| | Azo | Pigment dispersion | 2.8 | 2.1 | 1.4 | 2.4 |
| | pigment (A) | liquid B (*2) | | | | |
| | Humectant | Glycerol | 8 | 8 | 8 | 8 |
| | | Triethylene glycol | 8 | 8 | 8 | 8 |
| | Penetrant | Triethylene | 2 | 2 | 2 | 2 |
| | | glycol-n-butyl ether | | | | |
| | Surfactant | OLFIN (trade name) | 1 | 1 | 1 | 1 |
| | | E1010 (*3) | | | | |
| | | SUNNOL | 1 | 1 | 1 | 1 |
| | | (trade name) | | | | |
| | | NL1430 (*4) | | | | |

| | | | | |
|---|---|---|---|---|
| Water | balance | balance | balance | balance |

| | | | | |
|---|---|---|---|---|
| Q:A | 6:4 | 7:3 | 8:2 | 7:3 |
| Q + A) | 7 | 7 | 7 | 8 |
| Hue angle | A | A | A | B |
| Magenta chromaticness | A | A | A | A |
| Recording density | AA | AA | AA | AA |

### Table 2 (Following)—Legend

*1 Aqueous dispersion of solid solution of PV19 and PR122; numerical values in Table 2 indicate the solid content amounts of pigment
*5 Aqueous dispersion of PR122; numerical values in Table 2 indicate the solid content amounts of pigment
*6 Aqueous dispersion of PV19; numerical values in Table 2 indicate the solid content amounts of pigment
*2 Aqueous dispersion of PR48:3; numerical values in Table 2 indicate the solid content amounts of pigment
*3 Nonionic surfactant (acetylenic glycol-based surfactant) produced by Nissin Chemical Industry Co., Ltd; the numeric value in Table 2 indicates the active ingredient amount;
*4 Anionic surfactant produced by Lion Corporation; active ingredient 28% by weight; the numeric value in Table 2 indicates the active ingredient amount.

TABLE 2

| | | | Comparative Examples | | | |
|---|---|---|---|---|---|---|
| | | | 1 | 2 | 3 | 4 |
| Ink composition | Quinacridone | Pigment dispersion | 5 | — | — | — |
| (% by mass) | pigment (Q) | liquid A (*1) | | | | |
| | | Pigment dispersion | — | — | 3.5 | — |
| | | liquid C (*5) | | | | |
| | | Pigment dispersion | — | — | — | 3.5 |
| | | liquid D (*6) | | | | |
| | Azo pigment | Pigment dispersion | — | 5 | 1.5 | 1.5 |
| | (A) | liquid B (*2) | | | | |
| | Humectant | Glycerol | 8 | 8 | 8 | 8 |
| | | Triethylene glycol | 8 | 8 | 8 | 8 |
| | Penetrant | Triethylene | 2 | 2 | 2 | 2 |
| | | glycol-n-butyl ether | | | | |
| | Surfactant | OLFIN (trade name) | 1 | 1 | 1 | 1 |
| | | E1010 (*3) | | | | |
| | | SUNNOL (trade name) | 1 | 1 | 1 | 1 |
| | | NL1430 (*4) | | | | |

| | | | | |
|---|---|---|---|---|
| Water | balance | balance | balance | balance |

| | | | | |
|---|---|---|---|---|
| Q:A | 10:0 | 0:10 | 7:3 | 7:3 |
| Q + A | 5 | 5 | 5 | 5 |
| Hue angle | C | C | A | C |
| Magenta chromaticness | A | C | C | A |
| Recording density | B | C | A | B |

As indicated in Table 1, Examples 1 to 13 had good evaluation results of the hue angle, the magenta chromaticness, and the recording density. Namely, all the evaluation results were good. Since the hue angle and the magenta chromaticness were good in each of Examples 1 to 13, it was confirmed that a wide color reproduction gamut from magenta to red can be achieved.

In Examples 3 to 12 in which Q:A=8:2 to 6:4 was satisfied and Q+A was 5 to 7% by mass, the balance between the hue angle, the magenta chromaticness and the recording density was better than Example 2 in which Q:A=5:5 was satisfied, Example 1 in which Q+A was 4% by mass, and Example 13 in which Q+A was 8% by mass. Namely, any of the hue angle, the magenta chromaticness, and the recording density in Examples 3 to 12 was better than Examples 1, 2, and 13.

In Examples 6 to 12 in which Q:A=8:2 to 6:4 was satisfied and Q+A was 5.5 to 7% by mass, the evaluation result of the recording density was better than Examples 3 to 5 in which Q+A was 5% by mass.

As indicated in Table 2, in Comparative Example 1 in which no azo pigment was used, the evaluation result of the hue angle was bad. In Comparative Example 2 in which no quinacridone pigment was used, all the evaluation results including the hue angle, the magenta chromaticness, and the recording density were bad. In Comparative Example 3 in which PR122 was used as the quinacridone pigment instead of the solid solution of PV19 and PR122, the evaluation result of the magenta chromaticness was bad. In Comparative Example 4 in which PV19 was used, the evaluation result of the hue angle was bad.

As described above, in the water-based ink of the present disclosure, the wide color reproduction gamut from magenta to red can be achieved and the magenta chromaticness and the recording density are good. The water-based ink of the present disclosure is widely applicable, for example, as the water-based magenta ink for ink-jet recording, to various kinds of ink-jet recording.

What is claimed is:

1. A water-based ink for ink-jet recording, comprising:
a solid solution of a quinacridone pigment including C.I. Pigment Violet 19 and C.I. Pigment Red 122,
an azo pigment including C.I. Pigment Red 48:3, and
water.

2. The water-based ink for ink jet recording according to claim 1, wherein a mass ratio (Q:A) of a content (Q) of the solid solution of the quinacridone pigment to a content (A) of the azo pigment in an entire amount of the water-based ink is in a range of 8:2 to 5:5.

3. The water-based ink for ink-jet recording according to claim 1, wherein a total (Q+A) of a content (Q) of the solid solution of the quinacridone pigment and a content (A) of the azo pigment in an entire amount of the water-based ink is in a range of 4 to 8% by mass.

4. The water-based ink for ink-jet recording according to claim 1, wherein a mass ratio (Q:A) of a content (Q) of the solid solution of the quinacridone pigment to a content (A) of the azo pigment in an entire amount of the water-based ink is in a range of 8:2 to 6:4, and
wherein a total (Q+A) of the content (Q) of the solid solution of the quinacridone pigment and the content (A) of the azo pigment in the entire amount of the water-based ink is in a range of 5 to 7% by mass.

5. The water-based ink for ink-jet recording according to claim 4, wherein the total (Q+A) of the content (Q) of the solid solution of the quinacridone pigment and the content (A) of the azo pigment in the entire amount of the water-based ink is in a range of 5.5 to 7% by mass.

6. The water-based ink for ink jet recording according to claim 1, further comprising a surfactant.

7. The water-based ink for ink-jet recording according to claim 6, wherein the surfactant includes an acetylenic glycol-based surfactant.

8. The water-based ink for ink-jet recording according to claim 1, wherein the water-based ink has a hue angle of −5° to 11°.

9. The water-based ink for ink-jet recording according to claim 8, wherein the water-based ink has a hue angle of −1° to 7°.

10. The water-based ink for ink jet recording according to claim 1, further comprising a quinacridone pigment which is different from the solid solution.
